(19) United States
(12) Patent Application Publication
(10) Pub. No.: US 2012/0106730 A1
(43) Pub. Date: May 3, 2012

(54) TELEPHONE KEYPAD CONFIGURATION

(76) Inventor: Diane McGinty, Columbia, TN (US)

(21) Appl. No.: 12/938,782

(22) Filed: Nov. 3, 2010

(51) Int. Cl. H04M 1/02

(52) U.S. Cl. 379/433.07

(57) ABSTRACT

A keypad configuration for a telephone comprising: a first row, where said first row includes three keypads with the numbers seven, eight, nine designated sequentially on the keypads; a second row, where said second row includes three keypads with the numbers four, five, six designated sequentially on the keypads; a third row, where said third row includes three keypads with the numbers one, two, three designated sequentially on the keypads; and a fourth row, where said fourth row includes three keypads with an asterisk, a zero, and a pound sign designated on the keypads. In one exemplary embodiment, each keypad lights up upon depression for accuracy purposes.

### BACKGROUND OF THE INVENTION

1. Field of Invention

The present invention relates to a reconfiguration of a telephone keypad to have an arrangement compatible to a computer keyboard.

2. Description of Related Art

The telephone is a telecommunication device that transmits sound, specifically audio voice communication between two or more individuals. Telephones conduct point-to-point communication that allows at least two individuals to communicate via the telecommunications network that is associated with the telephone. Telephones consist of a microphone, an earphone, a ringer and a keypad to enter the telephone number that the user is calling. Modern day telephones handle communications on both landlines and through the cellular communications networks. Although earlier phones used a rotary dial system to dial the phone number essentially all modern phones use a touchtone keypad arrangement of numbers to enter the phone number of the recipient of the phone call. The standard telephone keypad configuration includes three columns and four rows where the first three rows are comprised of the digits one through nine and the last row is the asterisk, zero and pound sign. Each pad associated with a number emits a unique tone to distinguish it for dialing purposes. The layout of the digits is distinctly different than what is commonly shown on calculators or computer keypads. The first row of the standard telephone keypad includes the numerals one through three, the second row from four through six, and the last row seven through nine. Since many individuals use the computer keyboard configuration or calculator configuration of numbering, it would be advantageous to have such a keypad design for a telephone. Such a design would be especially useful for an individual who dials numerous numbers over a period of time such as a phone sales person or telecommunications operator.

### SUMMARY OF THE INVENTION

The present invention relates to a keypad configuration for a telephone comprising: a first row, where said first row includes three keypads with the numbers seven, eight, nine designated sequentially on the keypads; a second row, where said second row includes three keypads with the numbers four, five, six designated sequentially on the keypads; a third row, where said third row includes three keypads with the numbers one, two, three designated sequentially on the keypads; and a fourth row, where said fourth row includes three keypads with an asterisk, a zero, and a pound sign designated on the keypads. In one exemplary embodiment, each keypad lights up upon depression for accuracy purposes.

### BRIEF DESCRIPTION OF DRAWINGS

FIG. 1 depicts a keypad for a telephone configured in accordance with the present invention.

### DETAILED DESCRIPTION

The present invention relates to the keypad configuration which provides an alternative to the traditional telephone keypad. The present invention reconfigures the keypads so that the first row consists of numerals seven through nine and the third row consists of the numerals one through three. This reconfiguration of the keypad creates a keypad that's conducive or comparable to a computer keypad. This rearrangement of the keypad allows the user a configuration that's similar to a computer keypad and therefore may be more adaptable for office workers who routinely dial numbers repetitively through the day.

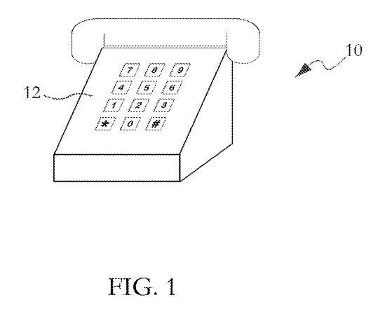

A phone 10 is depicted in FIG. 1 where the phone 10 includes a keypad Configuration 12. As noted the keypad Configuration 12 places the keypad numbering in sequence comparable to a computer keypad. Row 1 of the keypad configuration 12 includes the numbers seven, eight, nine; row 2—four, five, six, and row 3—one, two, three. The last row of the keypad Configuration 12 is the asterisk, zero, and pound sign. In addition to the reconfiguration of the keypads each keypad lights up upon depression therefore allowing the user to recognize exactly which number has been selected for accuracy and assurance. Keypad

Configuration 12 may be installed upon any phone, which may have had a keypad configuration similar to the traditional layout. Further the tones associated with each number would remain the same as associated with the original DTMF keypad frequencies that's associated with the current system on the conventional keypad configuration. The present invention therefore unites the configurations of the computer keyboard with a telephone therefore provides adds compatibility with a 4×3 grid provided on a telephone with the nine-digit keypad configuration of a computer. The instant invention has been shown and described in what it considers to be the most practical and preferred embodiments. It is recognized, however, that departures may be made there from within the scope of the invention and that obvious modifications will occur to a person skilled in the art.

What is claimed is:

1. A keypad configuration for a telephone comprising:
a. a first row, where said first row includes three keypads with the numbers seven, eight, nine designated sequentially on the keypads;
b. a second row, where said second row includes three keypads with the numbers four, five, six designated sequentially on the keypads;
c. a third row, where said third row includes three keypads with the numbers one, two, three designated sequentially on the keypads; and
d. a fourth row, where said fourth row includes three keypads with an asterisk, a zero, and a pound sign designated on the keypads.

2. The keypad configuration according to claim 1, where each keypad lights up upon depression.
